(19) United States
(12) Patent Application Publication
(10) Pub. No.: US 2025/0181034 A1
(43) Pub. Date: Jun. 5, 2025

(54) ARRANGEMENT FOR FASTENING A CRYSTAL OF A TIMEPIECE

(71) Applicant: BULGARI HORLOGERIE SA, Neuchâtel (CH)

(72) Inventors: François Perez, Founex (CH); Alfredo De Biase, Le Sentier (CH)

(73) Assignee: BULGARI HORLOGERIE SA, Neuchâtel (CH)

(21) Appl. No.: 18/842,343

(22) PCT Filed: Mar. 8, 2023
(86) PCT No.: PCT/EP2023/055858

§ 371 Date: Aug. 28, 2024

(30) Foreign Application Priority Data
Mar. 8, 2022 (CH) CH000238/2022

(51) Int. Cl. G04B 29/04; G04B 39/02

(52) U.S. Cl. CPC G04B 29/04; G04B 39/02

(57) ABSTRACT

The timepiece includes a case and a crystal delimiting an interior volume in which a watch movement is arranged, a device for fastening the crystal to the case at the periphery of the crystal, and a device for connecting the crystal, including at least one support stud arranged in the interior volume in a fixed manner relative to the case and engaging with the crystal outside its periphery fastened by the fastening device, by contact with the lower surface of the crystal, particularly in a central zone of the crystal.

The present invention relates to an arrangement for fixing a glass of a timepiece, and to a timepiece per se, particularly to an ultra-flat timepiece. The invention also relates to a method for fixing a glass of a timepiece that belongs to a more general method for manufacturing a timepiece.

In order to produce a timepiece with a small thickness, it is necessary to take into account the fact that the glass is liable to deform under external pressure. Specifically, reducing the thickness of a timepiece can rely on reducing the thickness of the glass and/or on bringing it closer to the movement and/or the hands. As a result, the effects of deformation of the glass become problematic, since it must be prevented from coming into contact with the movement or the hands, so as not to disrupt the running of the timepiece or even damage the movement. Furthermore, if the glass becomes weaker, it must also be ensured that it does not break in the event of deformation.

Document CH706978 describes a solution consisting in using a surface of the frame of a timepiece movement to form a stop that reduces the travel of the glass in the event of deformation, in order to prevent it from coming into contact with a hand. This solution works in extreme cases of severe deformation of the glass. In a normal configuration of the timepiece, such a stop has no effect. This solution therefore makes it possible to avoid certain extreme problems, but remains insufficient. For example, the glass can still experience slight deformations, such that it comes or does not come into contact with the stop, for example microvibrations, thus requiring the use of a glass that is sufficiently strong, in particular with a suitable thickness.

A general aim of the present invention is to propose a solution for fixing a glass to a case of a timepiece, said solution being particularly suitable for a timepiece of small thickness.

To this end, the invention is defined by the claims.

In particular, the invention is based on an arrangement for fixing a glass of a timepiece comprising a case, comprising a device for fixing the glass to the case at the periphery of the glass, wherein it comprises a device for connecting the glass comprising at least one support stud interacting with the glass away from its periphery or away from the watch case, in particular in a central region of the glass.

The at least one stud can comprise a lower portion for mounting on the timepiece, and an upper portion in contact with the lower surface of the glass.

The arrangement can comprise a plurality of support studs, in particular between 1 and 10, and a plurality of support studs in contact with the glass in its central region.

The arrangement for fixing a glass can comprise a plurality of support studs distributed substantially uniformly over a central region of the glass and/or in the vicinity of components of the movement intended to be positioned at a very small distance from the glass, such as a wheel or a hand.

The invention also relates to a timepiece, comprising a glass and a case, wherein it comprises an arrangement for fixing the glass to the case as previously defined.

The at least one support stud can be fixed to a bridge of the movement of the timepiece.

The at least one support stud can be fixed to a head of a screw of a bridge of the movement of the timepiece. The support stud can comprise an annular form capable of interacting with a protrusion of the screw of the bridge of the movement of the timepiece.

The at least one support stud can be fixed so as to be height-adjustable in order to be able to ensure it is in contact with the glass.

The glass can comprise a thickness of less than or equal to 0.4 mm, or even less than or equal to 0.35 mm, in particular between 0.2 and 0.4 mm, and/or the glass can comprise a diameter of greater than or equal to 30 mm, or even greater than or equal to 30 mm, and/or a diameter of less than or equal to 45 mm, or even less than or equal to 40 mm.

The timepiece can comprise a total thickness of less than or equal to 2 mm, or even less than or equal to 1.9 mm, or even less than or equal to 1.85 mm.

The invention also relates to a method for fixing a glass of a timepiece, wherein it comprises the following steps:
fixing the glass at its periphery to a case of the timepiece;
connecting the glass using at least one support stud that comes into contact with, or is optionally fixed to, the glass over a region away from its periphery or away from the case, in particular in the central portion of the glass.

Other advantages and features will emerge more clearly from the following description of a particular embodiment of the invention, which is given by way of non-limiting example and shown in the accompanying drawings, in which:

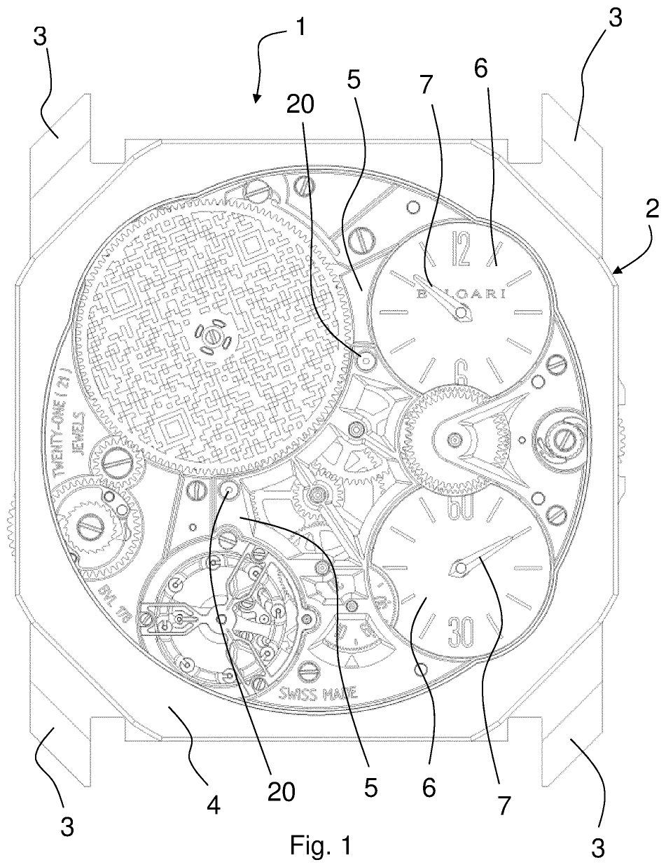

FIG. 1 shows a view from above of a timepiece according to an embodiment of the invention.

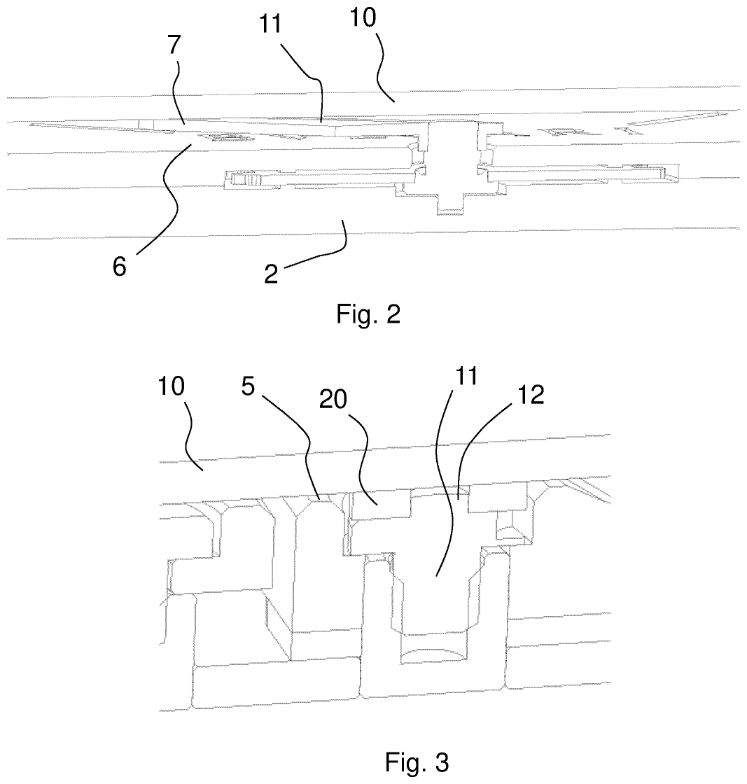

FIG. 2 shows a view in perpendicular section at a bridge of the timepiece according to the embodiment of the invention.

FIG. 3 shows a view in perpendicular section at a support stud of the timepiece according to the embodiment of the invention.

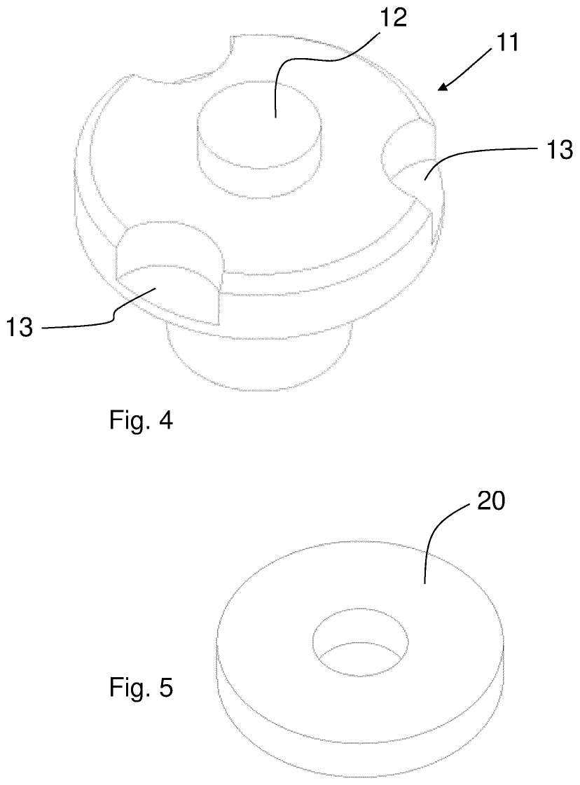

FIG. 4 shows a perspective view of a screw of the timepiece according to the embodiment of the invention.

FIG. 5 shows a perspective view of a support stud of the timepiece according to the embodiment of the invention.

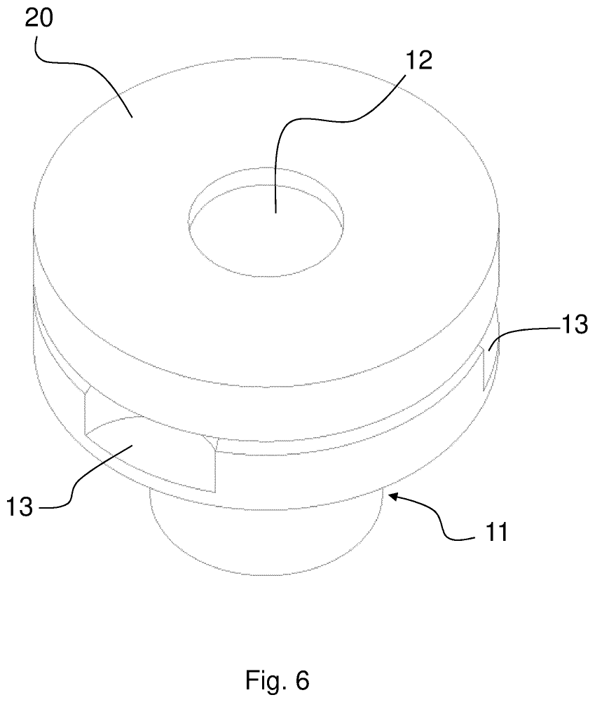

FIG. 6 shows a perspective view of the assembly of a support stud on the screw of the timepiece according to the embodiment of the invention.

In order to simplify the description, by convention, the term “horizontal direction” will be used for any direction parallel to the glass of the timepiece. The term “perpendicular direction” will be used for any direction perpendicular to the glass of the timepiece. The adjectives “upper” and “lower” will be used to designate elements or surfaces with reference to the perpendicular direction, being respectively positioned on the side viewed by the user of the timepiece and on the opposite side, for example on the side facing a wearer's wrist in the case of a wristwatch.

FIG. 1 shows a view from above of a timepiece 1 according to an embodiment of the invention. This timepiece 1 is a wristwatch comprising a case 2, which comprises lugs 3 provided for fixing watch-strap strands, which are not shown.

The case 2 comprises a bottom or plate and a case middle, and a bezel 4 arranged on the case middle on the periphery of the case 2. As a variant, any other architecture of the case 2 is conceivable.

The timepiece 1 further comprises a glass 10, which can hardly be seen in FIG. 1 and is first of all fixed in a conventional manner by a fixing device at its periphery, on the case 2, and more particularly on the case middle and/or on the bezel 4. This first fixing means can be an adhesive or a mechanical means. The bezel is fixed in a traditional manner to the case middle, for example using screws, such as octagon-head screws, from the bottom of the watch. Thus, this fixing device, which is rather traditional, involves regions of the periphery of the glass and corresponding regions on the watch case.

The timepiece 1 further comprises a timepiece movement, which is fixed in an upper portion using bridges 5. It also comprises at least one dial 6 and at least one hand 7. The case 2 and the glass entirely or partially delimit an interior volume of the timepiece, in which the timepiece movement is arranged.

FIG. 2 shows a view in section through a perpendicular plane of the timepiece 1. According to this embodiment, the timepiece is ultra-flat. Advantageously, the total thickness of the timepiece is less than or equal to 2 mm, or even less than or equal to 1.9 mm, or even less than or equal to 1.85 mm. This thickness can be greater than or equal to 1.7 mm.

As a result, first of all, the glass 10 is chosen with a very small thickness, for example of around 0.3 mm. Advantageously, the thickness of the glass is less than or equal to 0.4 mm, or even less than or equal to 0.35 mm. It is also advantageously greater than or equal to 0.2 mm, or even greater than or equal to 0.25 mm. This thickness is preferably constant. As a variant, it can be variable, in which case the abovementioned values are the minimum or average values. The glass 10 furthermore has a diameter of greater than or equal to 30 mm, or even greater than or equal to 35 mm. The glass 10 furthermore has a diameter of less than or equal to 45 mm, or even less than or equal to 40 mm. Its contour can be circular. As a variant, it can have any other form: square, rectangular, ellipsoidal, etc. In all cases, its area can remain within the same values as those resulting from the abovementioned diameter range. The glass 10 can be made from any known material, for example from sapphire.

In addition, the glass 10 is in the vicinity of the movement, in order to minimize the overall thickness of the timepiece. Thus, the space 11 between the lower surface of the glass 10 and the upper surface of a bridge 5 of the movement or of a hand 7, as shown schematically in FIG. 2, can be very small, for example less than or equal to 0.1 mm.

With the above-defined dimensioning, the glass 10 would be liable to deform in a non-negligible manner if it were fixed solely by the abovementioned fixing device, and this deformation would be sufficient for said glass to come into contact with the movement, in particular a bridge, which could cause the geartrain and/or a hand 7 to become clamped. For this reason, according to the embodiment, the glass 10 is furthermore held by one or more support studs 20, which come into contact with the lower surface of the glass 10. In other words, the glass 10 bears against the support stud or studs 20. Such a glass, on account of its reduced thickness, is furthermore liable to experience all kinds of vibrations and deformations, even of very low amplitude, without necessarily coming into contact with the movement or a hand. These deformations are liable to cause the glass to become worn and weakened. The support stud or studs 20 make it possible to eliminate or reduce this phenomenon.

According to an embodiment, a support stud 20 is advantageously arranged on an upper bridge 5 of the movement, or even on a plate. It thus extends vertically from such a bridge 5 until it comes into contact with the lower surface of the glass 10. As a variant, it can be fixed to any other surface of the movement or of the timepiece. Preferably, it is fixed away from a pin of the movement, so as not to risk disrupting the rotation of such a pin. It therefore extends advantageously from a fixed surface, with no connection to a rotating pin of the movement. It is therefore separate from a pin of the timepiece movement or from a moving element of the timepiece movement. Such a support stud 20 is thus mounted so as to be fixed relative to the timepiece, more precisely relative to the watch case 2, unlike components of the timepiece movement, such as geartrains and pivot pins, and unlike elements that are liable to deform.

The function of a support stud 20 is to supplement the device for fixing the glass provided at its periphery, by forming all or part of a connecting device, positioned in a region away from the periphery of the glass or away from the watch case, that is to say away from regions of the periphery of the glass and of the watch case on which the device for fixing the glass is used. The support stud therefore adds elements for holding the glass that are separate from and complementary to the traditional fixing device.

A support stud is thus preferably arranged in a central region of the glass 10. Such a central region can be defined as a disk of radius R/2 or 3R/4 of the glass, which is centered on the center of the glass, where R is the radius of the glass. If the glass does not have a form with a circular contour, the same principle can be applied by considering the disk of minimum radius in which the glass is inscribed. A support stud is therefore positioned in the interior volume of the timepiece and comprises a lower portion fixed to the timepiece, such as a plate or a bridge of the movement, and an upper portion in contact with the lower surface of the glass.

This connecting device comprising one or more support studs has the function of preventing the glass 10 from deforming, at least at a support stud 20. This construction allows a glass to be fixed, by combining the fixing device and the connecting device, such that it hardly deforms, if at all, so that it does not come into contact with the movement or a hand. More generally, it hardly experiences any deformations, if at all.

According to the embodiment shown in FIG. 1, two support studs 20 are used. Advantageously, the connecting device comprises a plurality of support studs 20, for example 2, 3, 4, 5 or 6, or more generally any number between 1 and 10.

Moreover, according to an embodiment, these support studs are advantageously distributed rather uniformly and at least partially away from the periphery of the glass. Preferably, they are positioned on a central portion of the timepiece. Thus, a plurality of support studs 20 can advantageously be positioned at the disk of radius R/2, or even of radius 3R/4, of the glass 10, where R is the radius of the glass. In other words, the central region is delimited by a circle of radius 3R/4, or even R/2, where R is the radius of the circle in which the glass 10 is inscribed. As a variant or in addition, the support stud or studs 20 can be positioned in the vicinity of the bridge 5 and/or hand 7 surfaces that are closest to the glass 10. The support studs 20 can be identical or different.

According to the preferred embodiment, which is shown in FIG. 3, a support stud 20 is fixed to a screw 11 of the movement, more precisely to a head 12 of a screw 11 fixed to a bridge 5 of the movement. To this end, the head 12 of the screw 11 is designed to comprise a first interaction device, for example a central pin, that is able to interact with a support stud 20.

FIGS. 4 to 6 illustrate, in this connection, an exemplary assembly of a screw 11 of a bridge of the movement with a support stud 20. FIG. 4 shows a screw 11. This screw 11 comprises a cylindrical 12 protruding portion 12 on its head, which extends around a vertical axis that coincides with the axis of the screw 11. Notches 13 are provided on the periphery of the screw head, in order to enable the insertion of a tool and the possible actuation of the screw 11. FIG. 5 shows a support stud 20, which has an annular form and a size that corresponds to the screw 11, in order to be able to interact with its head, as shown in FIG. 6, and to protrude above the head in terms of height, by exactly filling the space between the screw 11 and the glass 10, in order to come into contact with the glass 10, as shown in FIG. 3.

In such an embodiment, provision can be made for support studs 20 of different heights, which may be custom-manufactured, in order to perfectly fill the height between a bridge 5 and the glass 10. According to such an embodiment, a support stud 20 thus has a height calculated to correspond exactly to the distance between the movement and the glass, in particular in cases in which the construction clearances are small or negligible.

A support stud 20 is advantageously rigid enough to prevent the glass from deforming, while being flexible enough not to form a hard point on the glass, which would risk damaging it. To this end, the support stud 20 is preferably made of a rubber material or rigid polymer, for example a transparent silicone.

According to one variant embodiment that is not shown, the positioning of a support stud 20 can be height-adjustable. To this end, it can comprise a lower mounting portion that is screwed onto the movement, for example onto a bridge 5, such that its height can vary depending on the screwing. As a variant, any other mechanical height-adjustment solution is conceivable. Such an embodiment makes it possible to compensate for any clearances and/or to ensure contact with the glass in all cases, with any desired pressure, even when the construction clearances are non-negligible.

It should be noted that, in all cases, the lower surface of the glass 10 can comprise a coating at the point of contact with a support stud 20. Such a coating can have a first function of reinforcing the glass at the point of contact, and a second esthetic function of concealing the contact stud for a user of the timepiece.

The invention therefore relates to an arrangement for fixing a glass 10 of a timepiece, as described above. It also relates to a timepiece per se. As described above, it is particularly suitable for a timepiece with a very small thickness, in particular a wristwatch.

It should additionally be noted that the arrangement has been described as comprising at least one support stud that comes into contact with the glass, in order to keep its position at a constant height, in order to prevent it from deforming in the event of stress being exerted on its upper surface. As emerges implicitly from the preceding description, such contact is formed with the glass in its rest position, that is to say non-deformed position. In other words, the contact between the support stud and the glass is thus a permanent contact. As a variant, the support stud 20 can be fixed to the glass, for example by an adhesive or a mechanical means, and thus form a second device for fixing the glass.

In all cases, a support stud therefore behaves differently than a stop as described in document CH706978, which has no effect on the glass apart from when it is most significantly deformed. The support stud of the invention acts as an element for holding the glass in a non-deformed initial position, and acts permanently on this glass in order to hold it in this initial position. It therefore effectively contributes to the overall fixing of the glass to the timepiece.

The invention also relates to a method for fixing a glass to a timepiece, wherein it comprises the following steps:
fixing the glass 10 at its periphery to a case 2 of the timepiece;
connecting the glass 10 using at least one support stud 20 that comes into contact with, or is optionally fixed to, the glass 10 over a region away from its periphery, which is fixed in the preceding step, in particular in the central portion.

Advantageously, the method comprises a step of adjusting the height of the at least one support stud 20 in order to ensure it is in contact with the glass 10.

This method for fixing a glass is incorporated into a more general method for assembling a timepiece and for manufacturing a timepiece.

1. A timepiece comprising:
a case, and
a glass delimiting an interior volume in which a timepiece movement is arranged,
a fixing device for fixing the glass to the case at a periphery of the glass, and
a connecting device for connecting the glass comprising at least one support stud, the support stud being arranged in the interior volume so as to be fixed relative to the case, and the support stud interacting with the glass, away from the periphery of the glass fixed by the fixing device, through contact of the support stud with a lower surface of the glass.

2. The timepiece as claimed in claim 1, wherein the at least one support stud is in permanent contact with the lower surface of the glass or is fixed to the lower surface of the glass, so that the glass is held in place.

3. The timepiece as claimed in claim 1, wherein the at least one support stud comprises a lower portion for mounting on the timepiece, so that the support stud is mounted so as to be fixed relative to the case.

4. The timepiece as claimed in claim 1, wherein the timepiece comprises a plurality of support studs, in contact with the glass in a central region of the glass delimited by a circle having a radius of 3R/4, where R is a radius of the circle in which the glass is inscribed.

5. The timepiece as claimed in claim 4, wherein the plurality of support studs are distributed substantially uniformly over the central region of the glass and/or in a vicinity of components of the movement intended to be positioned at a very small distance from the glass.

6. The timepiece as claimed in claim 1, wherein the at least one support stud is fixed to a bridge of the timepiece movement or to a plate of the timepiece.

7. The timepiece as claimed in claim 6, wherein the at least one support stud is fixed to a head of a screw of the bridge.

8. The timepiece as claimed in claim 7, wherein the at least one support stud comprises an annular shape capable of interacting with a protrusion of the screw.

9. The timepiece as claimed in claim 1, wherein the at least one support stud is fixed so as to be height-adjustable in order to be able to ensure that the at least one support stud is in contact with the glass.

10. The timepiece as claimed in claim 1, wherein the glass comprises a thickness of less than or equal to 0.4 mm, and/or wherein the glass comprises a diameter of greater than or equal to 30 mm.

11. The timepiece as claimed in claim 1, wherein the timepiece comprises a total thickness of less than or equal to 2 mm.

12. The timepiece as claimed in claim 1, wherein the at least one support stud is separate from a pin of the timepiece movement or from a moving element of the timepiece movement.

13. A method for fixing a glass of a timepiece, wherein the method comprises:
fixing the glass at a periphery of the glass to a case of the timepiece;
connecting the glass using at least one support stud that comes into contact with, or is fixed to, the glass over a region away from the periphery of the glass.

14. The method as claimed in claim 13, wherein the at least one support stud interacts with the glass through contact of the support stud with the lower surface of the glass in a central portion of the glass.

15. The timepiece as claimed in claim 1, the at least one support stud interacts with the glass through contact of the support stud with the lower surface of the glass in a central region of the glass.

16. The timepiece as claimed in claim 4, wherein the circle delimiting the central region of the glass has a radius of R/2.

17. The timepiece as claimed in claim 4, wherein the plurality of support studs are distributed substantially uniformly in a vicinity of a wheel or a hand of the movement positioned at a very small distance from the glass.

18. The timepiece as claimed in claim 10, wherein the glass comprises a thickness in a range of from 0.2 to 0.4 mm.

19. The timepiece as claimed in claim 10, wherein the glass comprises a diameter in a range of from 30 mm to 45 mm.

20. The timepiece as claimed in claim 11, wherein the glass comprises a total thickness of less than or equal to 1.85 mm.
